(19) United States
(12) Patent Application Publication
(10) Pub. No.: US 2015/0260972 A1
(43) Pub. Date: Sep. 17, 2015

(54) STEREO MICROSCOPE SYSTEM

(71) Applicants: KOH YOUNG TECHNOLOGY INC., Seoul (KR); KYUNGPOOK NATIONAL UNIVERSITY INDUSTRY-ACADEMIC COOPERATION FOUNDATION, Daegu (KR)

(72) Inventors: Jong-Kyu Hong, Gwangju-si (KR); Hyun-Ki Lee, Daegu (KR); Min-Young Kim, Daegu (KR); Jae-Heon Chung, Gwangmyeong-si (KR)

(21) Appl. No.: 14/368,639

(22) PCT Filed: Jul. 30, 2013
(86) PCT No.: PCT/KR2013/006828

§ 371 Date: Jun. 25, 2014

(30) Foreign Application Priority Data
Jul. 30, 2012 (KR) 10-2012-0083207

(51) Int. Cl. G02B 21/22; G02B 21/02

(52) U.S. Cl. CPC G02B 21/22; G02B 21/025

(57) ABSTRACT

The present invention relates to a stereo microscope system, at least one optical axis system and a camera is used, and a first image through the first beam path and a second image through the second beam path have identical coordinates in which the first and second images are obtained from the camera, therefore, it is not required to revise an image during image registration, and as well as, to match mechanical compensation of coordinates of cameras, since the first image and second image have identical coordinates. According to the present invention, it is possible to provide a stereoscopic image with minimized loss of stereo effect and as well as, it is possible to observe a stereoscopic image more comfortable since an eye fatigue is minimized.

### TECHNICAL FIELD

Exemplary embodiments of the present invention relate to a stereo microscope system. More particularly, exemplary embodiments of the present invention relate to a stereo microscope system capable of observing a target object in a stereoscopic image.

### BACKGROUND ART

A microscope which is a kind of magnifying glass is not possible to distinguish a microstructure visually since it is comprised of two groups lens, such as an objective lens and an eyepiece.

It has been developed and widely used a stereo type microscope in which two eyepieces are used to observe a target object using two eyes of an observer.

As a stereotype microscope, there is Abbe type in which a target is observed by being parallel to an optical axis of an objective lens and Greenough type in which a target is observed by forming an angle to an optical axis of an objective lens.

The stereotype microscope described above is actually developed to be used for a various surgeries. Such a stereo microscope is capable of observing a target object directly through an eyepiece as well as is developed to observe a target object realizing in a virtual reality.

Hereinafter, with reference to a FIG. 1, conventional stereo microscope will be described in detail.

FIG. 1 is a figure explaining a structure of a general stereo microscope.

Referring to FIG. 1, in a conventional stereo microscope, a pair of zoom lens portions 130 are disposed between an objective lens 110 and a pair of imaging lens 120, a pair of cameras 140 capture images formed on the pair of imaging lens 120, the captured images, which are a left image 210 and a right image 220, are registered and are provided as a stereoscopic image of a target object.

As described above, in such a conventional stereo microscope, a pair of zoom lens portions 130 and a pair of imaging lens 120 are used as two optical axis of an optical system, and coordinates of the two images 210 and 220 are not exactly matched through a minute difference of the two optical axis of the optical system. And there is a problem that additional complex process is required such as revising the images 210 and 220 in a registration process of the images 210 and 220.

Meanwhile, it often happens that two captured images 210 and 220 which are captured by the two cameras are not matched according to a position and an inclination since two cameras 140 are used, and therefore a mechanical compensation is needed to match coordinates of the cameras.

Additionally, there is a problem that there is a loss of three-dimensional effect of the stereoscopic image as well as side effect such as eye fatigue is generated when observing the stereoscopic image.

### DISCLOSURE

### Technical Problem

Therefore, the technical problem of the present invention is to provide a stereo microscope system which does not requires revising process of the two images as well as a mechanical compensation to math coordinates of the cameras when images are registered in order to implement a stereoscopic image.

Also, the technical problem of the present invention is to provide a stereo microscope using one axis optical system and one camera. The one optical axis system is comprised of at least one zoom lens portion and one detector lens by using one-side open unit which passes alternatively a first beam and a second beam to a zoom lens portion.

### Technical Solution

According to an embodiment of the present invention, a stereo microscope includes an objective lens in which a reflected light from a target object passes through a first beam path and a second beam path, an one-side open unit disposed on the first and second beam paths to alternatively pass the first and second beams having passed the objective lens through the first and second beam paths, a zoom lens portion having a predetermined magnification ratio and disposed on the first and second beam paths to receive the first and second beams having alternatively passed the one-side open unit, a detector lens disposed on the first and second beam paths to receive the first and second beams having alternatively passed the zoom lens portion and form images of a target object, and a camera capturing images formed on the detector lens.

According to another embodiment of the present invention, a stereo microscope includes an objective lens in which a reflected light from a target object passes through a first beam path and a second beam path, an one-side open unit disposed on the first and second beam paths to alternatively pass the first and second beams having passed the objective lens through the first and second beam paths, a pair of zoom lens portions having a predetermined magnification ratio and disposed on the first and second beam paths to receive the first and second beams having alternatively passed the one-side open unit, a detector lens disposed on the first and second beam paths to receive the first and second beams having passed the pair of zoom lens portions, and form images of a target object, and a camera capturing images formed on the detector lens.

In one embodiment, the one-side open unit includes a shielding body disposed between the zoom lens portion and the objective lens and rotatable with respect to an optical axis such that the first and second beams having passed the objective lens through the first and second beam paths are shielded, and an opening portion formed through the shielding body to alternatively pass the first and second beams having passed objective lens through the first and second beam paths as the shielding body is rotated on the optical axis.

Herein, it may be preferable to replaceably arrange the one-side open unit between the objective lens and the zoom lens portion.

In another embodiment, the one-side open unit includes a shielding body disposed between the zoom lens portion and the objective lens and rotatable with respect to an optical axis such that the first and second beams having passed the objective lens through the first and second beam paths are shielded, a plurality of opening portions formed through the shielding body in which distances from the optical axis to each of the opening portions are different, and an open-close means disposed on the shielding body to open and close the opening portions. The first and second beams having passed the objective lens through the first and second beam paths may alternatively pass to the zoom lens portion by rotating the shielding body on the optical axis, in which only one opening portion is opened and selected by the open-close means.

Herein, the open-close means may be a plurality of shutters disposed on the shielding body to open and close the opening portions independently.

Alternatively, the open-close means may be a plurality of optical shutters disposed on the shielding body to pass or shield the first and second beams which flow into the zoom lens portion through the opening portions by changing optical transmissive properties.

In another embodiment, the one-side open unit includes a shielding body disposed between the objective lens and the zoom lens portion to shield the first and second beams having passed the objective lens through the first and second beam paths, a pair of opening portions formed though the shielding body which are symmetrical to each other in the optical axis to pass the first and second beams having passed the objective lens through the first and second beam paths to the zoom lens portion, and an open-close means to alternatively pass the first and second beams having passed the objective lens through the first and second beam paths to the zoom lens portion.

Herein, the open-close means may be a pair of shutters to open and close the pair of opening portions independently.

Alternatively, the open-close means may be a pair of optical shutters disposed on the shielding body to pass or shield the first and second beams which flow into the zoom lens portion through the opening portions by changing optical transmissive properties.

Meanwhile, the open-close means may include a rotating plate rotatably disposed between the shielding body and the objective lens or between the shielding body and the zoom lens portion to close the pair of opening portions, and an auxiliary opening portion formed on the rotating plate to open alternatively the pair of opening portions as the rotating plate is rotated.

Herein, it may be preferable to replaceably dispose the one-side open unit between the objective lens and the zoom lens portion.

In another embodiment, the one-side open unit includes a shielding body disposed between the objective lens and the zoom lens portion to shield the first and second beams having passed the objective lens through the first and second beam paths, at least two pairs of opening portions formed through the shielding body, which are symmetrical to each other in the optical axis and distances from the optical axis to each of the opening portions are different, and to pass the first and second beams having passed the objective lens through the first and second beam paths to the zoom lens portion, and an open-close means to close remaining pairs of opening portions except for selected one pair of opening portions among the at least two pairs of opening portions, and alternatively pass the first and second beams to the zoom lens portion by alternatively closing the selected one pair of opening portions, the first and second beams pass the objective lens through the first and second paths.

Herein, the open-close means may be a plurality of shutters disposed on the shielding body to open the opening portions independently.

Alternatively, the open-close means may be a plurality of optical shutters disposed on the shielding body to pass or shield the first and second beams which flow into the zoom lens portion through the opening portions by changing optical transmissive properties.

### Advantageous Effects

As described above, a stereo microscope according to an embodiment of the present invention is capable of generating stereoscopic images by using one optical axis system and one camera. The one optical axis system is comprised of one zoom lens portion and one detector lens through using an one-side open unit which alternatively passes first and second beams to a zoom lens portion.

Thus, a stereo microscope system according to an embodiment of the present invention does not need to revise images during a registration process and match mechanical compensation of coordinates of cameras since an image which is passed through the first beam path and an image which is passed through the second beam path have identical coordinates, in which the images are obtained from one optical axis system and one camera.

Therefore, a stereo microscope system according to an embodiment of the present invention provides a stereoscopic image with a minimized loss of stereo effect and as well as, a comfortable observation of stereoscopic images with minimized eye fatigue.

### DESCRIPTION OF DRAWINGS

FIG. 1 is a figure explaining conventional stereo microscope;

FIG. 2 is a schematic diagram of a stereo microscope system according to a first embodiment of the present invention;

FIG. 3 is a schematic diagram of a stereo microscope system according to a second embodiment of the present invention;

FIG. 4 is a schematic diagram explaining an one-side open unit of a stereo microscope system according to a third embodiment of the present invention;

FIG. 5 is a schematic diagram explaining an one-side open unit of a stereo microscope system according to a fourth embodiment of the present invention;

FIG. 6 is a figure of an open-close means according to a fifth embodiment of the present invention; and

FIG. 7 is a schematic diagram explaining an one-side open unit of a stereo microscope system according to a sixth embodiment of the present invention.

### MODE FOR INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that, although the terms first, second, third etc. may be used herein to describe various elements, components, regions, layers and/or sections, these elements, components, and/or sections should not be limited by these terms. These terms are only used to distinguish one element, component, region, layer or section from another region, layer or section. Thus, a first element, component, or section discussed below could be termed a second element, component, or section without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For convenience, same numerals are used for identical or similar elements of an apparatus of cutting a tempered substrate and the conventional one.

Hereinafter, with reference to the drawings, preferred embodiments of the present invention will be described in detail.

### First Embodiment

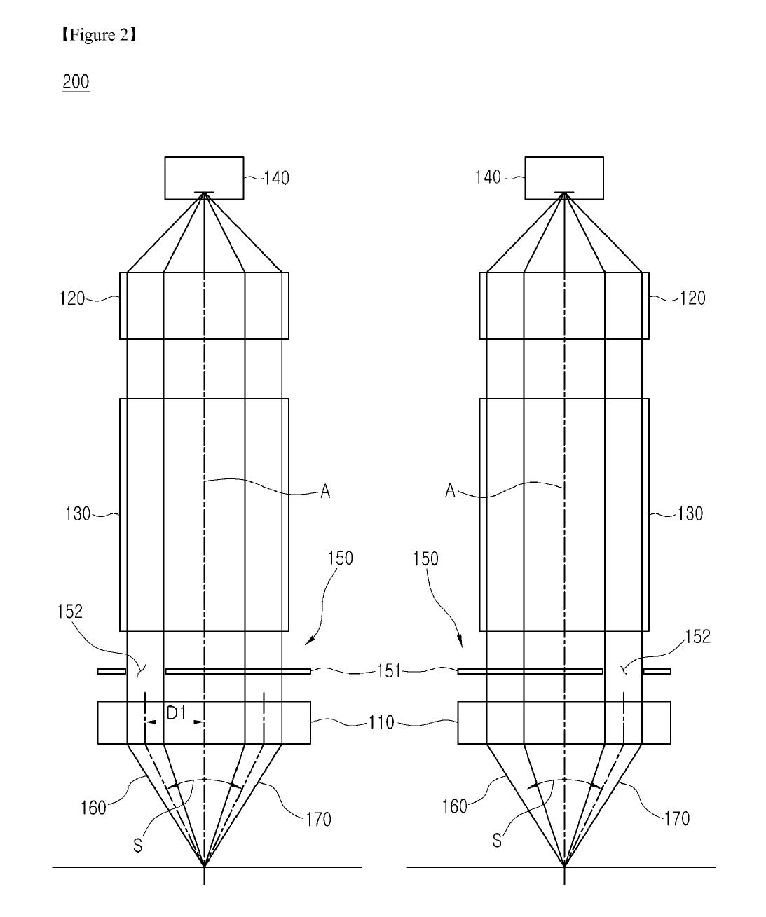

FIG. 2 is a schematic diagram of a stereo microscope system according to a first embodiment of the present invention;

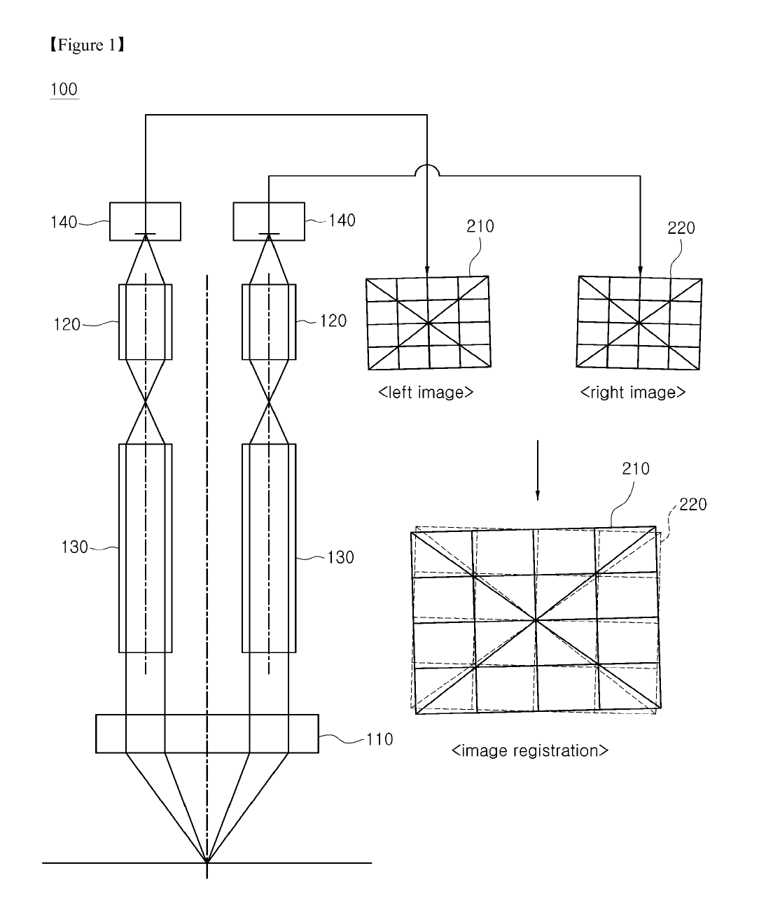

Hereinafter, for the convenience of description, same reference numerals of a stereo microscope system 100 of FIG. 1 are given to the same/similar parts.

Referring to FIG. 2, a stereo microscope system 200 according to a first embodiment of the present invention includes an objective lens 110, an one-side open unit 150, a zoom lens portion 130, a detector lens 120, and a camera 140.

The objective lens 110 passes a reflected beam of a target object (not shown), and the beam pass through a first beam path 160 and a second beam path 170.

The one-side open unit 150 is disposed on the first and second beam paths to be positioned between the objective lens 110 and the zoom lens portion 130. The one-side open unit 150 alternatively passes the beams having passed the objective lens through the first and second beam paths to the zoom lens portion.

In other words, the one-side open unit 150 alternatively passes the first and second beams having passed the objective lens through the first and second beam paths by passing the first beam while shielding the second beam and passing the second beam while shielding the first beam, and alternatively operating them.

The zoom lens portion 130 has a predetermined magnification ratio, may be disposed on the first and second beam paths 160 and 170 to be positioned between the one-side open unit 150 and the detector lens 120. And the zoom lens portion 130 receives the first and second beams having are alternatively passed through the one-side open unit 150, and zooms in or out an image of the target object in a predetermined magnification ratio.

In other words, the zoom lens portion 130 receives one of the beams which passes the one-side open unit 150 among the first and second beams, and zooms in or out an image in a predetermined magnification ratio generated from the beam of the target object.

Therefore, in a stereo microscope system 200 according to the first embodiment of the present invention, one zoom lens portion 130 is disposed on the first and second beam paths 160 and 170 to be positioned between the one-side open unit 150 and the detector lens 120.

The detector lens 120 is disposed on the first and second beam paths 160 and 170 to be positioned between the zoom lens portion 130 and the camera 140, receives the first or second beams having passed through the zoom lens portion 130 and forms an image of the target object by the first and second beams.

Also, the detector lens 120, likewise the zoom lens portion, may be disposed on the first and second beam paths 160 and 170 such that only one detector lens 120 is positioned on rear of the zoom lens portion 130 since the detector lens 120 receives any of the beams having sequentially passed the one-side open unit 150 and the zoom lens 130 and forms images of the target object.

The camera 140 is capable of capturing images of the target object which are formed on the detector lens 120. Also, one camera 140 may be disposed on a rear of the detector lens 120 since the camera captures images which are formed on the one detector lens 120.

As described above, a stereo microscope system 200 according to the first embodiment of the present invention is capable of generating a stereoscopic image by using one optical axis system which is comprised of one zoom lens portion 130 and one detector lens 120 in which an one-side open unit is included to alternatively pass a first beam or a second beam to a zoom lens portion 130.

Additionally, it is possible to generate a stereoscopic image by repeating capturing process of images of a target object formed on the detector lens 120 more than two times since only one detector lens 120 is used which is the last process, and one camera captures images formed on the detector lens 120 in which the images are formed through a first and second beam paths 160 and 170.

Therefore, a stereo microscope system 200 according to the first embodiment of the present invention is capable of having identical coordinates between an image obtained from the camera 140 through the first beam path 160 and an image obtained from the camera 140 through the second beam path 170 by using one camera 140 and one optical axis system.

Therefore, a stereo microscope system 200 does not need to revise in a registration process of the images obtained from the first and second beam paths 160 and 170, and is not affected by problems caused from a position or an inclination of the camera 140.

In other words, there is no inconvenient to revise the two images since the two images obtained from different beam paths have identical coordinates, and no mechanical compensation is required to match coordinate of plurality of cameras.

Therefore, in a stereo microscope system 200 according to the first embodiment of the present invention, stereo effect of a stereoscopic image is not lost as well as capable of observing a stereoscopic image with minimized an eye fatigue.

Subsequently, detailed description of the one-side open unit is explained below.

An one-side open unit 150 of the stereo microscope system according to the first embodiment of the present invention may be formed in a rotary type to alternatively pass the first and second beams to the zoom lens portion 130 through alternatively opening an opening portions 152, in which the opening portions 152 are formed in one side and are alternatively opened as the one-side open unit 150 is rotated on the optical axis A.

In one embodiment, the one-side open unit 150 may include a shielding body 151 and an opening portions 152.

The shielding body 151 may be arranged between the objective lens 110 and the zoom lens 130 to be rotated on an optical axis A to shield the first and second beams having passed the objective lens through the first and second beam paths 160 and 170.

The opening portions 152 are formed through one side of the shielding body 151 to alternatively pass the first and second beams having passed the objective lens 110 through the first and second beam paths to the zoom lens portion 130 as the shielding body is rotated on the optical axis A.

Meanwhile, the one-side open unit 150 may be detachably and replaceably arranged between the objective lens 110 and the zoom lens portion 130. In other words, since the one-side open unit 150 is detachably and replaceably arranged between the objective lens 110 and the zoom lens portion 130, another one-side open unit in which distances from the optical axis to the opening portions 152 are different may be used to change a solid angle of the stereo microscope system 200.

Herein, at least one of a manual exchange method in which a user changes and an automatic rotation exchange method in which at least two different one-side open unit is automatically separated and changed may be used to replace the one-side open unit 150.

A stereo microscope system according to the first present invention is capable of adjusting a solid angle S by only adjusting distance from the optical axis A to the opening portions 152 without replacing any of lens modules of optical system by using one optical axis system with one zoom lens portion 130 and one detector lens 120.

Therefore, a stereo microscope system 200 according to the first embodiment of the present invention is capable of adjusting a solid angel without changing any lens modules by changing only one-side open unit in which distance from the optical axis A to the opening portions is different

### Second Embodiment

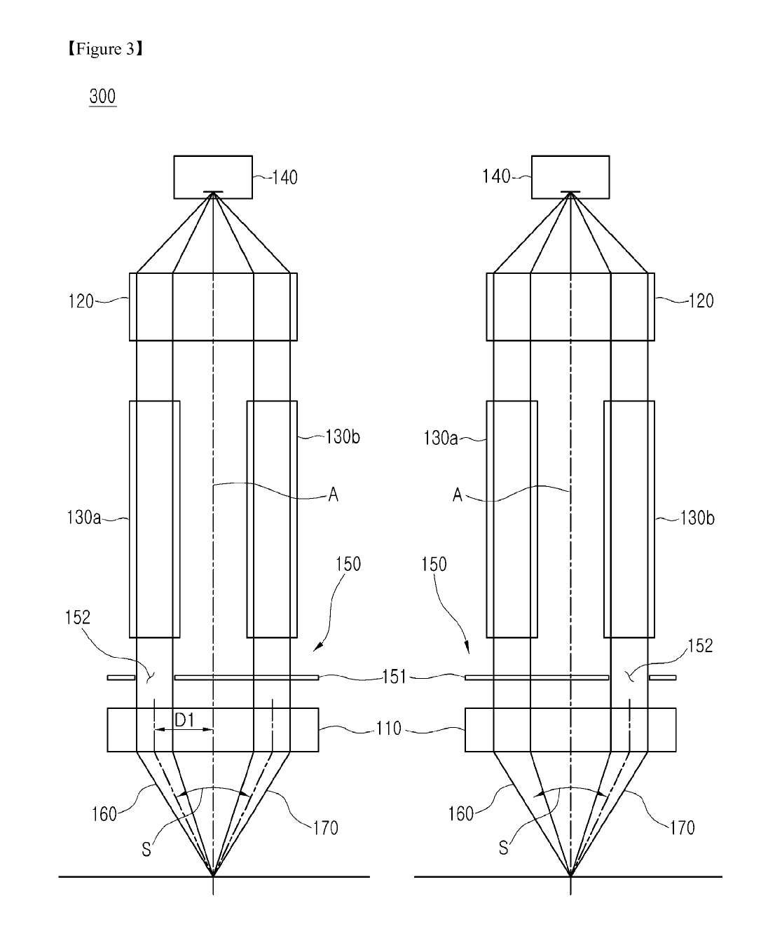

FIG. 3 is a schematic diagram of a stereo microscope system according to a second embodiment of the present invention.

A stereo microscope system 300 according to an embodiment of the present invention is substantially the same as the first embodiment of the present invention except for the zoom lens portion 130, detailed explanation of other elements except for the zoom lens portion are skipped, and same numerals are used to elements which are identical to the first embodiment.

Referring to FIG. 3, in a stereo microscope system 300 according to an embodiment of the present invention, a first and second zoom lens portions 130a and 130b may be arranged between the one-side open unit 150 and the detector lens 120.

In more detail, the first zoom lens portion 130a is disposed between the one-side open unit 150 and the detector lens 120 to be positioned on the first beam path 160, and the second zoom lens portion 130b may be disposed between the one-side open unit 150 and the detector lens 120 to be positioned on the second beam path 170.

Therefore, it is possible to zoom in or out in a predetermined magnification ratio since the first zoom lens portion 130a and the second zoom lens portion 130b receive the first and second beams having passed alternatively the one-side open unit 150, respectively.

### Third Embodiment

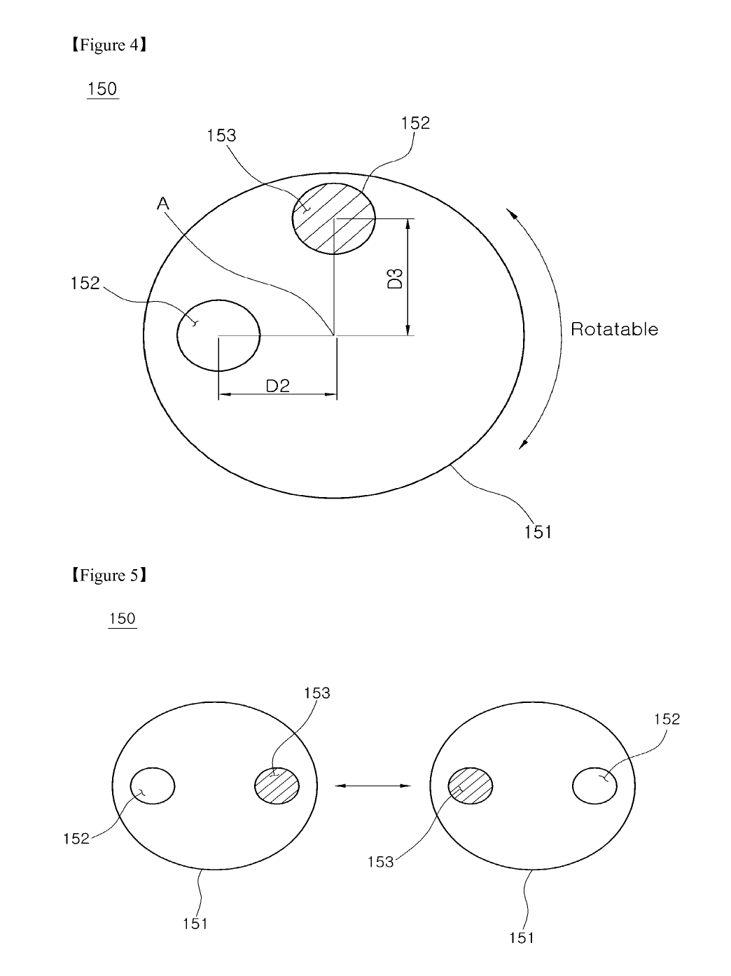

FIG. 4 is a schematic diagram explaining an one-side open unit of a stereo microscope system according to a third embodiment of the present invention.

A stereo microscope system according to an embodiment of the present invention is substantially the same as the stereo microscope system 100 of the first embodiment or the second embodiment except for an one-side open unit 150, detailed explanation of other elements except for the one-side open unit are skipped, and same numerals are used to elements which are identical to the first and second embodiments.

Referring to FIGS. 2-4, an one-side open unit 150 of a stereo microscope system according to an embodiment of the present invention includes a shielding body 151, a plurality of opening portions 152, and an open-close means 153.

The shielding body 151 may be arranged between the objective lens 110 and the zoom lens portion 130 to be rotatable on an optical axis A such that first and second beams having passed the objective lens 110 through the first and second beam paths 160 and 170 are shielded.

The plurality of opening portions 152 may be formed through the shielding body such that distances D2 and D3 from the optical axis to the opening portion are different. And the open-close means 153 may be disposed on the shielding body 151 to open and close the opening portions 152 independently.

In some embodiment, the open-close means 153 may be a plurality of shutters disposed on the shielding body 151 to independently open and close the opening portions 152.

In another embodiment, the open-close means may be a plurality of optical shutters disposed on the shielding body 151 to pass or shield the first and second beams flowing into the zoom lens portion through the opening portions by changing optical transmissive properties.

As described above, plurality of opening portions, in which distances D2 and D3 from the optical axis A to the opening portions are different, are formed through the shielding body 151, the shielding body 151 is rotated on the optical axis A in which any one selected opening portion is open state to obtain a desired solid angle S by the open-close means 153, and an one-side open unit 150 according to an embodiment is capable of sequentially passing the first and second beams having passed through the objective lens 110 to the zoom lens portion 130 through the first and second beam paths 160 and 170.

Therefore, a stereo microscope system according to an embodiment is capable of adjusting a solid angle S by only opening the opening portion 152 of desired position without replacing an one-side open unit.

In other words, an opening portion 152 which has a distance D2 to obtain desired solid angle is opened among the plurality of opening portions 152 by the open-close means 152 while rest of them are closed state, the one-side open unit is rotated on the optical axis A, and stereoscopic image with desired solid angle S is obtained by sequentially passing through the first and second beams to the zoom lens portion 130.

Meanwhile, in a stereo microscope system according to an embodiment, one zoom lens portion 130 may be arranged between the one-side open unit 150 and the detector lens 120 as the first embodiment, and as well as, each of the first and second zoom lens portions 130a and 130b may be arranged between the one-side open unit 150 and the detector lens 120 as the second embodiment.

### Fourth Embodiment

FIG. 5 is a schematic diagram explaining an one-side open unit of a stereo microscope system according to a fourth embodiment of the present invention.

A stereo microscope system according to an embodiment of the present invention is substantially the same as the stereo microscope system 100 of the first embodiment or the second embodiment except for an one-side open unit 150, detailed explanation of other elements except for the one-side open unit are skipped, and same numerals are used to elements which are identical to the first and second embodiments.

Referring FIGS. 2-3, and 5, an one-side open unit 150 may include a shielding body 151, a pair of opening portions 152, and an open-close means.

The shielding body 151 may be disposed between the objective lens 110 and the zoom lens portion 150 to shield the first and second beams having passed the objective lens 110 through the first and second beam paths 160 and 170.

The pair of opening portions 152 is formed through the shielding body to be symmetric to each other in the optical axis A to pass the first and second beams having passed the objective lens 110 through the first and second beam paths 160 and 170 to the zoom lens portion 130.

The open-close means 153 alternatively closes the pair of opening portions and alternatively passes the first and second beams having passed the objective lens 110 through the first and second beam paths 160 and 170 to the zoom lens portion 130. In other words, the open-close means closes opening portions positioned on the other side when opening portion of one side is opened, closes opening portion positioned on one side when opening portion of the other side is opened to alternatively pass the first and beams having passed the objective lens 110 through the first and second beam paths 160 and 170 to the zoom lens portion 130.

For example, the open-close means 153 may be a pair of shutters disposed on the shielding body 151 to independently open and close the pair of opening portion 152.

In another example, the open-close means 153 may be a pair of optical shutters disposed on the shielding body 151 to pass or shield the first and second beams having passed through the first and second beam paths 160 and 170 to the zoom lens portion 130 by changing optical transmissive properties.

### Fifth Embodiment

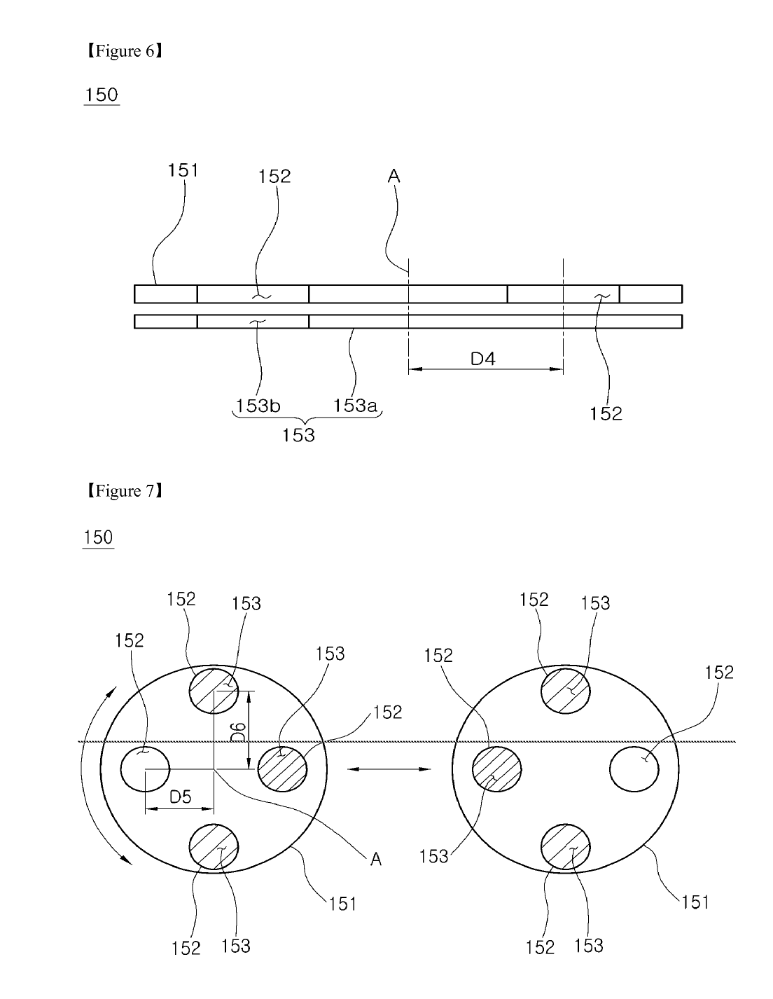

FIG. 6 is a figure of an open-close means according to a fifth embodiment of the present invention.

Referring to FIGS. 2-3, and 6, an open-close means of a stereo microscope system according to an embodiment may include a rotating plate 153a and an auxiliary opening portion 153b.

The rotating plate 153a is disposed between the objective lens 110 and the shielding body 151 to close the pair of opening portions. Also, although it is not shown in the figure, the rotating plate 153a may be rotatably arranged between the shielding body 151 and the zoom lens portion 130 to close the pair of opening portions 152.

The auxiliary opening portion 153b is formed through the rotating plate 153a to alternatively open the pair of opening portions 152 as the rotating plate is rotated.

Meanwhile, such an one-side open unit 150 may be detachably and replaceably arranged between the objective lens 110 and the zoom lens portion 130. In other words, since the one-side open unit 150 is detachably and replaceably arranged between the objective lens 110 and the zoom lens portion 130, another one-side open unit 150 in which distance D4 from the optical axis A to the pair of opening portions 152 is different may be replaced and used to change a solid angle S of a stereo microscope system.

Also a stereo microscope system according to an embodiment, one zoom lens portion 130 may be arranged between the one-side open unit 150 and the detector lens 120 as the first embodiment, and as well as, each of the first and second zoom lens portions 130a and 130b may be arranged between the one-side open unit 150 and the detector lens 120 as the second embodiment.

### Sixth Embodiment

FIG. 7 is a schematic diagram explaining an one-side open unit of a stereo microscope system according to a sixth embodiment of the present invention.

A stereo microscope system according to an embodiment of the present invention is substantially the same as the stereo microscope system 100 of the first embodiment or the second embodiment except for an one-side open unit 150, detailed explanation of other elements except for the one-side open unit are skipped, and same numerals are used to elements which are identical to the first and second embodiments.

Referring to FIG. 7, an one-side open unit 150 of an embodiment includes a shielding body 151, at least two pairs of opening portions 152, and an open-close means 153.

The shielding body 151 may be arranged between the objective lens 110 and the zoom lens portion 130 to shield the first and second beams having passed the objective lens 110 through the first and second beam paths 160 and 170.

The at least two pairs of opening portions may be formed through the shielding body 151 in which distances D5 and D6 from the optical axis A to the opening portions are different and symmetrical to each other in the optical axis A, and the at least two pairs of opening portions to pass the first and second beams having passed the objective lens 110 through the first and second beam paths 160 and 170 to the zoom lens portion 130

The open-close means 150 may close the remaining pairs of opening portions except for the one selected pair of opening portions among the at least two pairs of opening portions 152. And the open-close means 150 alternatively closes the selected one pair of opening portions 152 and the first and second beams having passed the objective lens 110 through the first and second beam paths 160 and 170 pass to the zoom lens portion 130 through the one selected pair of opening portions 152.

In one embodiment, the open-close means 153 may be a plurality of shutters disposed on the shielding body 153 to independently open and close the opening portions 152.

In another embodiment, the open-close means 153 may be a plurality of optical shutters disposed on the shielding body 153 to pass or shield the first and second beams having passed the objective lens 110 through the first and second beam paths 160 and 170 to the zoom lens portion 130 by changing optical transmissive properties.

As described above, at least two pairs of opening portions 152 are formed through the shielding body 151 in which distances D5 and D6 from the optical axis A to the opening portions are different and symmetrical to each other in the optical axis A, one pair of opening portions is selected to obtain a desired solid angle S, the rest of opening portions 152 except for the one selected pair of opening portions 152 are shielded state, the one selected pair of opening portions 152 is alternatively opened and closed and therefore, the first and second beams having passed the objective lens 110 through the first and second beam paths sequentially pass to the zoom lens portion 130.

Therefore, a stereo microscope system according to an embodiment is capable of adjusting a solid angle S by alternatively opening and closing a pair of opening portions 152 without replacing an one-side open unit 150 in which one pair of opening portions 152 is selected to obtain a desired solid angle S while the remaining pairs of opening portions are closed.

Meanwhile, a stereo microscope system according to an embodiment, one zoom lens portion 130 may be arranged between the one-side open unit 150 and the detector lens 120 as the first embodiment, and as well as, each of the first and second zoom lens portions 130a and 130b may be arranged between the one-side open unit 150 and the detector lens 120 as the second embodiment.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A stereo microscope system comprising:
an objective lens through which a reflected beam from a target object passes via a first beam path and a second beam path;
an one-side open unit disposed on the first and second beam paths to alternatively pass the first and second beams having passed through the objective lens through the first and second beam paths;
a zoom lens portion having a predetermined magnification ratio and disposed on the first and second beam paths to receive the first and second beams having alternatively passed the one-side open unit;
a detector lens disposed on the first and second beam paths to receive the first and second beams having alternatively passed the zoom lens portion, and form images of the target object according the first and second beams; and
a camera capturing images formed on the detector lens.

2. A stereo microscope system comprising:
an objective lens through which a reflected beam from a target object pass via a first beam path and a second beam path;
an one-side open unit disposed on the first and second beam paths to alternatively pass the first and second beams having passed the objective lens through the first and second beam paths;
a pair of zoom lens portions, each of which has a predetermined magnification ratio and is disposed on the first and second beam paths to receive the first and second beams having alternatively passed the one-side open unit;
a detector lens disposed on the first and second beam paths to receive the first and second beams having alternatively passed each of the zoom lens portions and form images of the target object according to the first and second beams; and
a camera capturing images formed on the detector lens.

3. The stereo microscope system of claim 1, wherein the one-side open unit comprises:
a shielding body disposed between the objective lens and the zoom lens portion and rotatable with respect to an optical axis to shield the first and second beams having passed the objective lens through the first and second beam paths; and
an opening portion formed through the shielding body and alternatively passing the first and second beams which have passed through the first and second beam paths as the shielding body is rotated on the optical axis, to the zoom lens portion.

4. The stereo microscope system of claim 3, wherein the one-side open unit is detachable and replaceably disposed between the objective lens and the zoom lens portion.

5. The stereo microscope system of claim 1, wherein the one-side open unit comprises:
a shielding body disposed between the objective lens and the zoom lens portion and rotatable with respect to an optical axis to shield the first and second beams having passed the objective lens through the first and second beam paths;
a plurality of opening portions formed through the shielding body, wherein distances from the optical axis to the opening portions are different; and
an open-close means disposed on the shielding body to open and close the opening portions,
wherein the first and second beams having passed the objective lens through the first and second beam paths alternatively pass to the zoom lens portion by rotating the shielding body on the optical axis in which one opening portion selected by the open-close means is in open state.

6. The stereo microscope system of claim 5, wherein the open-close means are a plurality of shutters disposed on the shielding body to open and close the opening portions independently.

7. The stereo microscope system of claim 1, wherein the open-close means are a plurality of optical shutters disposed on the shielding body to pass or shield the first and second beams by changing optical transmissive properties wherein the first and second beams flow into the zoom lens portion through the opening portions.

8. The stereo microscope system of claim 5, wherein the one-side open unit comprises:
a shielding body disposed between the objective lens and the zoom lens portion to pass or shield the first and second beams having passed the objective lens through the first and second beam paths;
a pair of opening portions formed through the shielding body to be symmetrical to each other in the optical axis, and pass the first and second beams having passed the objective lens through the first and second beam paths to the zoom lens portion; and
an open-close means to alternatively pass the first and second beams having passed the objective lens through the first and second beam paths to the zoom lens portion to the zoom lens portion.

9. The stereo microscope system of claim 8, wherein the open-close means is a pair of shutters formed on the shielding body to open and close the pair of opening portions independently.

10. The stereo microscope system of claim 8, wherein the open-close means is a pair of optical shutters formed on the shielding body to pass or shield the first and second beams flowing into the zoom lens portion through the opening portions by changing optical transmissive properties.

11. The stereo microscope system of claim 8, wherein the open-close means comprises:
a rotating plate rotatably disposed between the shielding body and the zoom lens portion to close the pair of opening portions; and
an auxiliary opening portion formed through the rotating plate to alternatively open the pair of the opening portions formed through the shielding body as the rotating plate is rotated.

12. The stereo microscope system of claim 8, wherein the one-side open unit is detachably and replaceably disposed between the objective lens and the zoom lens portion.

13. The stereo microscope system of claim 1, wherein the one-side open unit comprises:
a shielding body disposed between the objective lens and the zoom lens portion to shield the first and second beams having passed the objective lens through the first and second beam paths;
at least two pairs of opening portions formed through the shielding body, wherein the opening portions are symmetrical to each other in the optical axis and distances from the optical axis to the opening portions are different, and pass the first and second beams having passed the objective lens through the first and second beam paths to the zoom lens portion;
an open-close means closing the remaining opening portions except for the one selected pair of opening portions, alternatively closing the selected pair of opening portions, and alternatively passing the first and second beams having passed the objective lens through the first and second beam paths to the zoom lens portions through the selected pair of opening portions.

14. The stereo microscope system of claim 13, wherein the open-close means are a plurality of shutters disposed on the shielding body to open and close the pair of opening portions independently.

15. The stereo microscope system of claim 13, wherein the open-close means are a plurality of optical shutters disposed on the shielding body to pass or shield the first and second beams which flow into the zoom lens portion through the opening portions by changing optical transmissive properties.

16. The stereo microscope system of claim 2, wherein the one-side open unit comprises:
a shielding body disposed between the objective lens and the zoom lens portion and rotatable with respect to an optical axis to shield the first and second beams having passed the objective lens through the first and second beam paths; and
an opening portion formed through the shielding body and alternatively passing the first and second beams which have passed through the first and second beam paths as the shielding body is rotated on the optical axis, to the zoom lens portion.

17. The stereo microscope system of claim 2, wherein the one-side open unit comprises:
a shielding body disposed between the objective lens and the zoom lens portion and rotatable with respect to an optical axis to shield the first and second beams having passed the objective lens through the first and second beam paths;
a plurality of opening portions formed through the shielding body, wherein distances from the optical axis to the opening portions are different; and
an open-close means disposed on the shielding body to open and close the opening portions,
wherein the first and second beams having passed the objective lens through the first and second beam paths alternatively pass to the zoom lens portion by rotating the shielding body on the optical axis in which one opening portion selected by the open-close means is in open state.

18. The stereo microscope system of claim 2, wherein the open-close means are a plurality of optical shutters disposed on the shielding body to pass or shield the first and second beams by changing optical transmissive properties wherein the first and second beams flow into the zoom lens portion through the opening portions.

19. The stereo microscope system of claim 2, wherein the one-side open unit comprises:
a shielding body disposed between the objective lens and the zoom lens portion to shield the first and second beams having passed the objective lens through the first and second beam paths;
at least two pairs of opening portions formed through the shielding body, wherein the opening portions are symmetrical to each other in the optical axis and distances from the optical axis to the opening portions are different, and pass the first and second beams having passed the objective lens through the first and second beam paths to the zoom lens portion;
an open-close means closing the remaining opening portions except for the one selected pair of opening portions, alternatively closing the selected pair of opening portions, and alternatively passing the first and second beams having passed the objective lens through the first and second beam paths to the zoom lens portions through the selected pair of opening portions.
